(19) United States
(12) Patent Application Publication
(10) Pub. No.: US 2001/0032112 A1
(43) Pub. Date: Oct. 18, 2001

(54) Method and system for improved matching and scheduling

(76) Inventor: Aaron M. Linz, Charlotte, NC (US)

Correspondence Address: HUNTON & WILLIAMS, 1900 K Street, N.W., Washington, DC, 20006-1109, US

(21) Appl. No.: 09/750,097

(22) Filed: Dec. 29, 2000

Related U.S. Application Data
(60) Provisional application No. 60/173,724, filed on Dec. 30, 1999.

(51) Int. Cl. G06F 17/60

(52) U.S. Cl. 705/8

(57) ABSTRACT

A method, system, and program providing improved techniques for selecting candidates filling predetermined criteria. The techniques are particularly suitable for screening resumes, matching job applicants to specific employment opportunities, and for scheduling interviews for the selected applicants.

### CROSS REFERENCE TO RELATED APPLICATIONS

This application claims the benefit of provisional patent application Ser. No. 60/173,724 filed Dec. 30, 1999, the disclosure of which is incorporated herein by reference.

### BACKGROUND OF THE INVENTION

The present invention relates generally to scheduling of events over a computer network. More particularly, the present invention relates to a method, system, and program for scheduling meetings such as job interviews over the internet.

Systems are known for conducting employment searches over the Internet. In fact, search sites for employment opportunities are some of the most-visited sites on the Internet. However, currently available employment-related sites on the Internet offer limited capabilities.

U.S. Pat. No. 5,832,497 to Taylor discloses an electronic automated information exchange and management system. A computer-implemented system manages an exchange of information between job applicants and employers. A first database includes job postings, each of which is stored in a job record. The system can search on a plurality of keywords in the job record to identify a job record suitable for a particular applicant. The system can then facilitate creation of a resume record and designation of the resume record for a separate resume database. The resume database can be searched to identify candidates for a particular employment position.

U.S. Pat. No. 5,978,768 to McGovern et al. discloses a computerized job search system and method for posting and searching job openings using a computer network. The system allows an employer to advertise positions on the Internet, directly receive resumes from prospective candidates, and efficiently organize and screen the received resumes. The system further includes the capability of monitoring employment advertisements for an individual job seeker and automatically notifying the job seeker when a position for which the job seeker is suitable becomes available. The system also allows multiple companies to advertise job positions at a single location accessible over the Internet by a job seeker, and allows the job seeker to communicate directly with a particular company if the job seeker is interested in further information relating to a particular position at the company. Typically, this last feature involves providing a link to the company's website which may include specific details about the particular position.

While the foregoing and other systems facilitate employment-related searching and information exchange over the Internet, such systems are generally directed to a relatively early step in the employment or recruiting process- that is, the matching of potential candidates for particular job openings. Because of this focus, significant limitations prevent such systems from being useful during other steps in the employment process, particularly relating to scheduling interviews or other meetings. Further, even with respect to the matching of candidates and openings, the systems described above still present limitations.

It would be desirable for a system, method, or program to provide for an automated matching between specific available job openings and particular candidates. It would further be desirable for such a system to be able to facilitate the scheduling of an interview or other meeting between an interested party, such as a job candidate, and one or more representatives of a particular entity, such as an employer. It would still further be desirable to facilitate an information exchange between the job candidate and the employer after the job candidate is selected for an interview.

### SUMMARY OF THE INVENTION

The present invention overcomes the limitations described above, and achieves additional advantages, by providing for a method, system, and program for facilitating a matching of candidates with available opportunities, including facilitating the exchange of information relevant to the candidate and/or to the specific opportunities, and facilitating the scheduling of an interview or similar meeting.

In accordance with a preferred embodiment, a system is provided which stores (or has access to) position information relevant to a particular job opening, such as a job listing, and which stores (or has access to) candidate information relevant to a particular candidate, such as a resume. The system performs an automatic matching of candidates to particular job openings using keyword matching, natural language searching techniques, between the job listings and resumes to determine potential matches and to generate a list of candidates for an available position.

The automatically generated list of candidates can be presented to the employer for approval of candidates, or the list can be used without modification as the basis for scheduling interviews. Candidates selected for interviews can be notified by electronic mail, facsimile, or other message automatically generated by the system, or can be notified by telephone. Once notified, the candidate can access on line additional information relevant to the position, such as company brochures, annual reports, application forms, or other literature, and can access an interview schedule, which can include a proposed date, proposed time, directions or other logistical information, and a identification of people whom the applicant will meet.

Numerous aspects of the system, method and/or program of the present invention achieve significant advantages over known online employment systems, including allowing increased information exchange and facilitating the scheduling of an interview.

### BRIEF DESCRIPTION OF THE DRAWINGS

The present invention can be understood more fully by reading the following Detailed Description of Preferred Embodiments of the invention, in conjunction with the accompanying drawings, in which:

FIG. 1 is a block diagram of a computer network suitable for implementing a method, system or program according to the present invention; and

FIG. 2 is a flow chart describing a method according to one embodiment of the present invention.

### DETAILED DESCRIPTION OF THE INVENTION

For purposes of explanation, the following description assumes the application of the present invention in an employment context; that is, to facilitate the exchange of information between a job seeker, applicant, or candidate and a company or other employing entity. However, it will be appreciated that the principles of the present invention can similarly be applicable in other contexts, such as work proposals submitted by companies, dating, or other contexts where persons or companies are matched to particular opportunities, situations, or other persons, and in which a scheduled meeting, telephone conference, or other interaction is desirable.

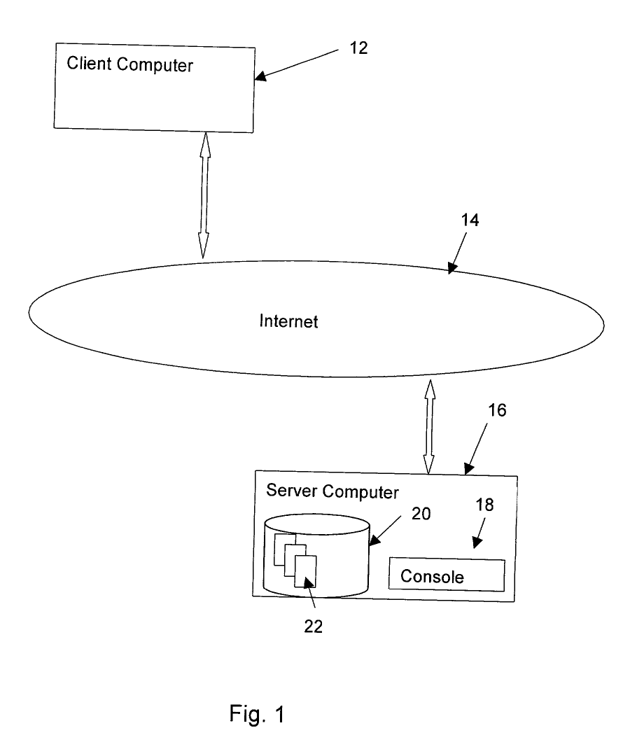

An Internet computer system 10 is generally illustrated in FIG. 1. A conventional client computer system 12, executing a client browser application that supports the HTTP protocol, is connected typically through an Internet Service Provider (ISP) to the Internet 14. A server computer system 16 is also coupled typically through an Internet Service Provider to the Internet 14. The server computer system 16, controlled by a local console 18, executes a Web server application conventionally known as a HTTP server. In addition, the server computer system 16 preferably provides local storage for at least one, though typically many, Web pages.

The client computer system requests a Web page by issuing a URL request through the Internet 14 to the server system 16. A URL consistent with the present invention may be a simple URL of the form:

<protocol identifiers>://<server path>/<web page path>

A “protocol identifier” of “http” specifies the conventional hyper-text transfer protocol. A URL request for a secure Internet transaction typically utilizes the secure protocol identifier “https,” assuming that the client browser and Web server are presumed to support and implement the secure sockets layer. The “server path” is typically of the form “prefix.domain,” where the prefix is typically “www” to designate a Web server and the “domain” is the standard Internet sub-domain.top-level-domain of the server system 16. The optional “web page path” is provided to specifically identify a particular hyper-text page maintained by the Web server.

In response to a received URL identifying an existing Web page, the server system 16 returns the Web page, subject to the HTTP protocol, to the client computer system 12. This Web page typically incorporates both textural and graphical information including embedded hyper-text links that permit the client user to readily select a next URL for issuance to the Internet 14.

The URL issued from the client system 12 may also be of a complex form that identifies a common gateway interface (CGI) program on a server system 16. Such a HTML hyperlink reference is typically of the form:

<form action-http://www.vendor.com/cgi-bin/logon.cgi method=post>

A hyper-text link of this form directs the execution of the logon.cgi program on an HTTP server in response to a client side selection of an hyperlink. A logon form supported by a logon CGI program is typically used to obtain a client user login name and password to initiate an authenticated session between the client browser and Web server for purposes of supporting, for example, a purchase transaction.

It is assumed that the system of FIG. 1 has access to at least a first database including information descriptive of one or more job opportunities and a second database including information descriptive of one or more candidates. The first database can be created manually by human resources or other personnel having knowledge of the particular job opportunities to be included in the database, and access to the database. While the second database can also be generated manually, by human resources or other personnel having access to candidate information supplied by resumes, employment applications, or other sources, the second database can also be generated automatically in accordance with one aspect of the invention. More particularly, the second database can be generated by scanning resumes or other materials submitted by applicants. In accordance with one aspect of the present invention, the resumes, whether submitted as paper copies or as electronic documents, can be scanned to extract keywords, and matched to keywords descriptive of the job opportunities which are similarly extracted from the first database. Alternatively, the resumes and job opportunities in the first database can be scanned using natural language searching techniques, such as those disclosed in U.S. Pat. Nos. 5,884,302, 5,836,771, 5,404,295, 5,309,359, or 5,794,050, to determine suitable matches. It should also be noted that the matching technique can be supplemented by other employer-specific criteria- for example, the matching method or program can be designed to automatically exclude candidates having more than a threshold number of jobs within a certain period of time, or to assign a more favorable status to job applicants whose resumes include certain keywords having a more favorable status (e.g., resumes which mention specific degrees, certifications, or other credential can be assigned a more favorable status).

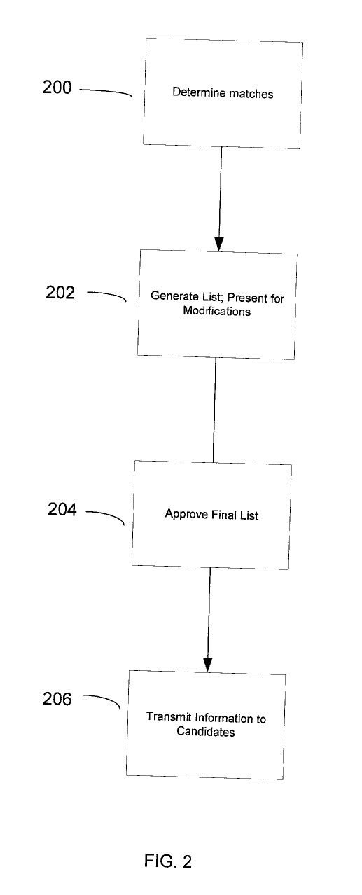

FIG. 2 is a flow chart describing one implementation of a method in accordance with the present invention. Such a method can be implemented in the system of FIG. 1, by loading a software program onto a machine readable storage medium, where the program includes specific machine readable instructions for performing the various steps of the method. The method of FIG. 2 begins in step 200, where it is assumed that the first and second databases have been established as described above. In step 200, matches between job applicants and specific job opportunities are determined, for example by keyword searching of resumes and job opportunities, natural language searching of resumes and job opportunities, or manually by human resources personnel reviewing resumes, and a list of matches is generated. In step 202, the list is presented to human resources or other decision-making personnel (e.g., via a computer display) for modifications. In step 204, a final list of applicants is approved by the human resources or other decision-making personnel. In step 206, the applicants are notified, by electronic mail, facsimile, or other means over the computer network. The notification to the applicants in step 206 preferably includes information such as: a proposed date for an interview or other meeting, a proposed time for the interview, representatives of the employer who are expected to be present for the interview directions or other logistical information to assist the applicant in making plans to attend the interview, copies of forms to be completed by the applicant in advance of the interview, company literature (which can be general or specific to the particular job opportunity involved), or other similar information. It will be appreciated that the notification in step 206 can be provided as an electronic mail message with links written in hypertext markup language (HTML) to allow the notified applicant to access any or all of the information included in the notification over the Internet.

While the foregoing description includes numerous details, it is to be understood that these are included for illustrative purposes only, and that these details are not limitations of the invention. Many modifications can be made to the examples described above without departing from the spirit and scope of the invention, as defined by the following claims and their legal equivalents.

What is claimed is:

1. A method for scheduling a personal meeting over a computer network, comprising the steps of:
scanning a first database including data entries descriptive of each of one or more applicants;
scanning a second database including data entries descriptive of each of one or more applicant criteria;
generating a list of one or more applicants matching certain of the one or more applicant criteria based on the scanning of the first and second databases; and
sending a message to the one or more applicants on the list, the message including information describing at least one of the following: a proposed meeting date, a proposed meeting time, persons to be present during a meeting, information required of the applicant prior to a meeting, and directions to a meeting.

2. The method of claim 1, wherein at least some of the information in the message is in the form of html links to information accessible over the Internet.

3. The method of claim 1, wherein the criteria include desired qualifications for one or more jobs.

4. The method of claim 1, further comprising the step of receiving the information descriptive of one or more applicants over the computer network.

5. The method of claim 1, further comprising the step of modifying the list to add or remove applicants prior to the step of sending.

6. The method of claim 1, wherein the step of sending is performed by transmitting the message over the computer network.

7. The method of claim 1, wherein the steps of scanning are performed by extracting keywords present in the first and second databases, and the step of generating is performed by matching data entries in the first and second databases having a minimum number of common keywords.

8. The method of claim 1, wherein the steps of scanning are performed using natural language searching of data entries in the first and second databases, and the step of generating is performed by matching natural language interpretations of data entries in the first and second databases.

9. The method of claim 1, further comprising the step of refining the one or more applicant criteria to include criteria not related to keywords.

10. The method of claim 1, further comprising the step of assigning certain of the one or more applicant criteria a higher status.

11. A machine-readable storage medium encoded with computer instructions for scheduling a meeting, comprising: one or more instructions for transmitting a message to an applicant over a computer network, the message including information descriptive of at least one of: a proposed meeting time, a proposed meeting date, a proposed meeting place, persons expected to attend a proposed meeting, information required from the applicant prior to a proposed meeting, and directions to a proposed meeting; and
one or more instructions for responding over the computer network to a request for information from an applicant for additional information.

12. The medium of claim 11, further comprising:
one or more instructions for scanning a first database containing data entries descriptive of each of one or more applicants, and for scanning a second database containing data entries descriptive of each of one or more criteria; and
One or more instruction for generating a list of applicants matching certain of the one or more criteria based on the scanning of the first and second databases.

13. The medium of claim 11, wherein the criteria include desired qualifications for one or more specific job opportunities.

14. The medium of claim 11, wherein the message includes hypertext markup language links to the information.

15. The medium of claim 12, wherein the one or more instructions for scanning include one or more instructions for extracting keywords from data entries in the first and second databases, and for matching data entries having matching keywords.

16. The medium of claim 12, wherein the one or more instructions for scanning include one or more instructions for performing natural language interpretation of data entries in the first and second databases, and for matching data entries in the first and second databases based on a matching of the natural language interpretations.
